(19) United States
(12) Patent Application Publication
(10) Pub. No.: US 2011/0130180 A1
(43) Pub. Date: Jun. 2, 2011

(54) GRAIN LOSS SAMPLING DEVICE

(76) Inventors: Norman VAN BRABANT, Morinville (CA); Gary VAN BRABANT, Morinville (CA)

(21) Appl. No.: 12/908,940

(22) Filed: Oct. 21, 2010

(30) Foreign Application Priority Data
Nov. 30, 2009 (CA) 2 687 185

(51) Int. Cl. A01F 12/32

(52) U.S. Cl. 460/101

(57) ABSTRACT

A sieve tray underlies an exit path of chaff from a harvesting combine, wherein grain is retained in the sieve tray by air pressure provided by a blower. A sieve tray support frame is provided for supporting the sieve tray. The sieve tray support frame has one pivotally mounted frame member movable between a tray supporting and a tray releasing position. A solenoid is provided for remotely moving the pivotally mounted frame member from the tray supporting to the tray releasing position wherein the sieve tray drops onto the field for inspection.

### FIELD

There is described a sampling device that assists a farmer in determining whether grain is being discharged from a harvesting combine along with chaff.

### BACKGROUND

U.S. Pat. No. 4,393,704 (Bartko) discloses a method of reducing grain loss of a harvesting combine and an associated grain loss sampling device. The method proposed by Bartko is sound. If a farmer can accurately determine the amount of grain being lost, he can adjust the blower speed on the combine to reduce such grain loss. However, the grain loss sampling device proposed by Bartko did not function as intended, as grain was blown away with the chaff. The present grain loss sampling device is intended to address shortcomings noted in the Bartko device.

### SUMMARY

There is provided a sieve tray underlying an exit path of chaff from the combine, wherein grain is retained in the sieve tray by air pressure provided by the blower. A sieve tray support frame is provided for supporting the sieve tray. The sieve tray support frame has one pivotally mounted frame member movable between a tray supporting and a tray releasing position. A solenoid is provided for remotely moving the pivotally mounted frame member from the tray supporting to the tray releasing position wherein the sieve tray drops onto the field for inspection.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a harvesting combine with a sieve tray in accordance with the invention.

FIG. 2 is a bottom plan view of the sieve tray illustrated in FIG. 1.

FIG. 3 is a top plan view of the sieve tray illustrated in FIG. 2.

FIG. 4 is a side elevation view of the frame member supporting the sieve tray in the tray supporting position; and

FIG. 5 is a side elevation view of the frame member in the tray releasing position wherein the tray is released.

FIG. 6 is a side elevation view of a harvesting combine with the sieve tray dropped into the field.

### DETAILED DESCRIPTION

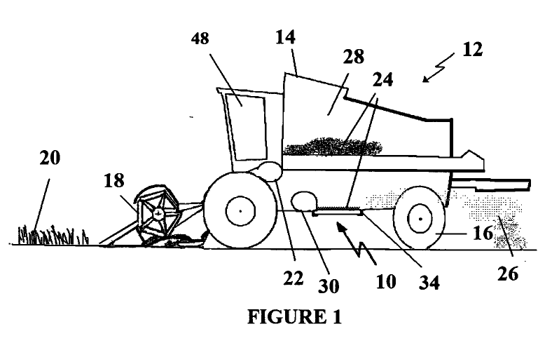

A sieve tray for a harvesting combine generally identified by reference numeral 10, will now be described with reference to FIGS. 1 through 6. Referring to FIG. 1, there is illustrated a harvesting combine generally referenced by the numeral 12. Harvesting combine 12 has a vehicle body 14, a pair of drive wheels 16, a cutter 18 disposed transverse to vehicle body 14 for cutting a crop 20 to be harvested and drawing crop 20 into combine 12. A thresher 22 is provided to dislodge grain 24 from chaff 26. Sieve tray 10 is provided for separating the grain 24 from chaff 26. Also provided is a grain storage 28 for capturing grain 24 and a blower 30 to blow chaff 26 out of combine 12. Sieve tray 10 underlies the exit path of chaff 26 from combine 12, wherein grain 24 is retained in sieve tray 10 by air pressure provided by blower 30.

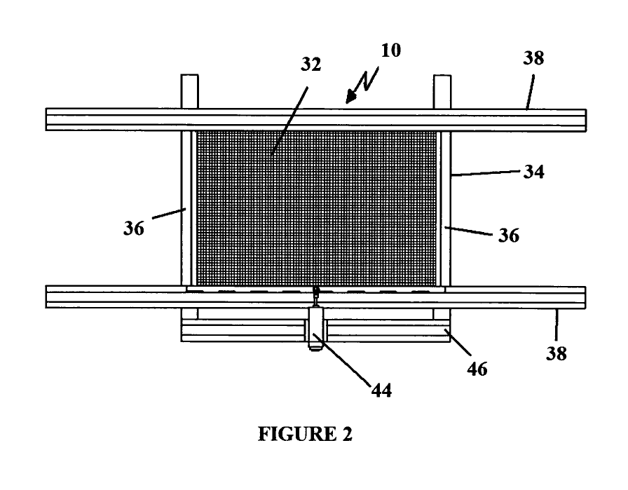

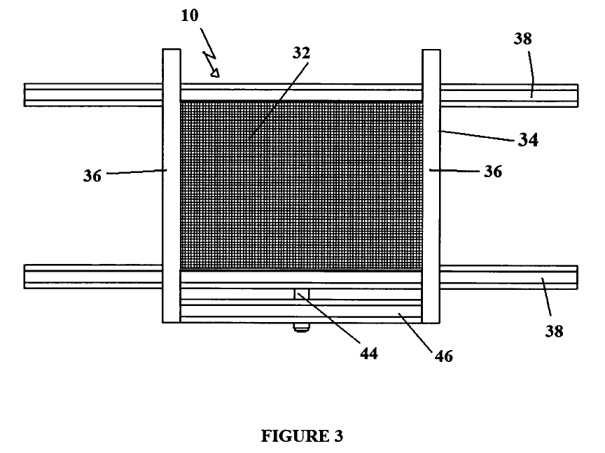

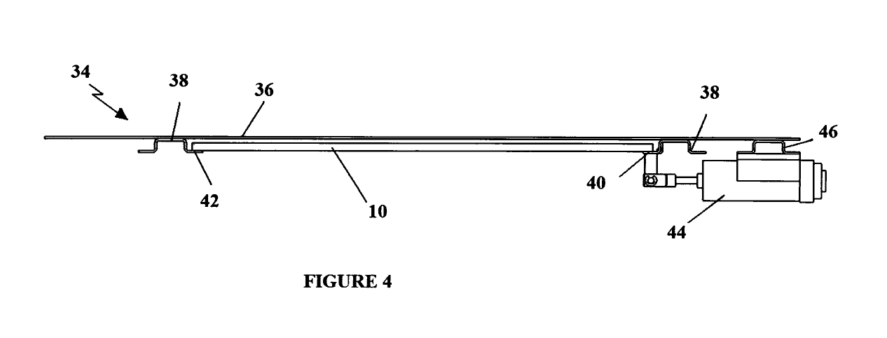

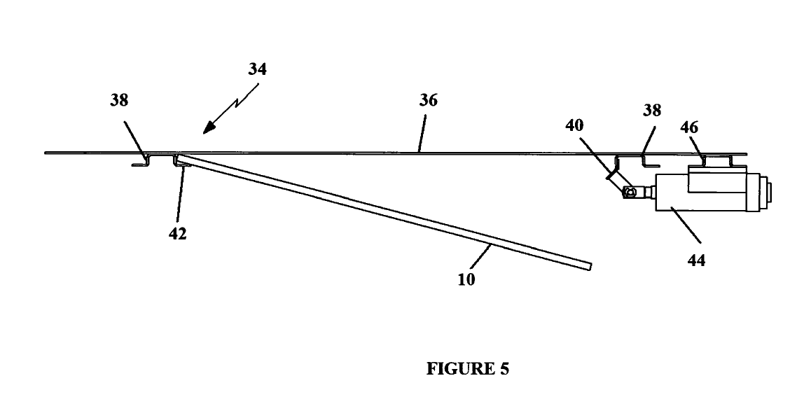

Referring to FIG. 2, sieve tray 10 has a centrally disposed perforated screen 32. A sieve tray support frame 34 is provided for supporting sieve tray 10 within harvesting combine 12 illustrated in FIG. 1. Referring to FIGS. 2 and 3, sieve tray support frame 34 has two upper opposed rails 36 and two bottom opposed side rails 38 which serve to support sieve tray 10 within sieve support frame 34. Two opposed upper rails 36 overlie sieve tray 10 while two opposed bottom rails 38 underlie sieve tray 10. Upper rails 36 and lower rails 38 are fixed to harvesting combine 12 as illustrated in FIG. 1. Referring to FIGS. 4 and 5, sieve tray support frame 34 has one pivotally mounted frame member 40 on one of opposed bottom rails 38, with a stationary lip 42 provided on other of opposed bottom rails 38 for maintaining sieve tray 10 in position within sieve tray support frame 34. Pivotally mounted frame member 40 is movable between a tray supporting position illustrated in FIG. 4, and a tray releasing position illustrated in FIG. 5.

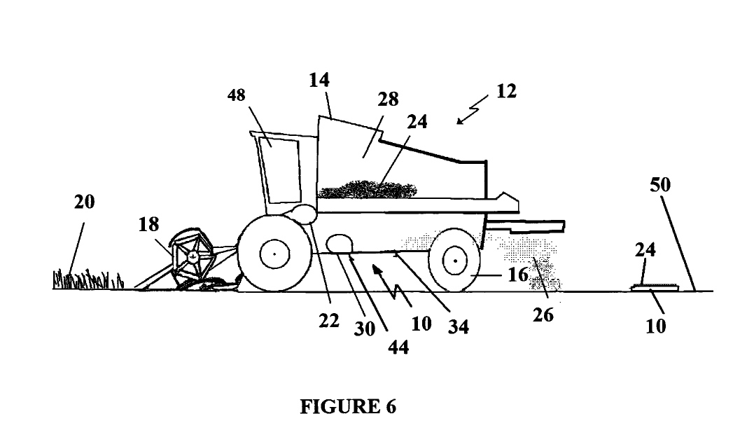

Referring to FIG. 3, a solenoid 44 is mounted to a fifth rail 46 which runs parallel to bottom side rails 38. Referring to FIG. 4, solenoid 44 is remotely activated to move pivotally mounted frame member 40 from the tray supporting position to the tray releasing position illustrated in FIG. 5. If desired, solenoid 44 can be activated remotely by operator of harvesting combine 12 from cab 48. Referring to FIG. 5, upon release, sieve tray 10 drops from sieve tray support frame 34 of harvesting combine 12 onto field 50 for inspection as illustrated in FIG. 6.

### Operation:

Referring to FIGS. 1 and 6, as harvesting combine 12 moves through field 50, cutter 18 which is disposed transverse to vehicle body 14 cuts crop 20 to be harvested and draws crop 20 into combine 12. Thresher 22 dislodges grain 24 from chaff 26 while sieve tray 10 is provided for separating grain 24 from chaff 26. Grain storage 28 captures grain 24 and blower 30 blows chaff 26 out of harvesting combine 12. Sieve tray 10 underlies the exit path of chaff 26 from combine 12 such that grain 24 is retained in sieve tray 10 by air pressure provided by blower 30. Sieve tray support frame 34 serves to support sieve tray 10 within harvesting combine 12 as illustrated in FIG. 1. Referring to FIG. 4, solenoid 44 is remotely activated to move pivotally mounted frame member 40 from the tray supporting position to the tray releasing position illustrated in FIG. 5 thereby dropping sieve tray 10 from sieve tray support frame 34 onto field 50 for inspection as illustrated in FIG. 6. After inspection, sieve tray 10 can be reinserted into sieve tray support frame 34 between upper rails 36 and lower rails 38 of tray support frame 34 as shown in FIG. 4.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. In a harvesting combine having a vehicle body, a pair of drive wheels, a cutter disposed transverse to the vehicle body for cutting a crop to be harvested and drawing the crop into the combine, a thresher to dislodge grain from chaff, means for separating the grain from the chaff, grain storage for capturing the grain and a blower to blow the chaff out of the combine, the improvement comprising:
a sieve tray underlying the exit path of the chaff from the combine, wherein grain is retained in the sieve tray by air pressure provided by the blower;
a sieve tray support frame for supporting the sieve tray, the sieve tray support frame having one pivotally mounted frame member movable between a tray supporting and a tray releasing position; and
a solenoid for remotely moving the pivotally mounted frame member from the tray supporting to the tray releasing position wherein the sieve tray drops onto the field for inspection.
